(19) United States
(12) Patent Application Publication
(10) Pub. No.: US 2026/0356380 A1
(43) Pub. Date: Nov. 12, 2026

(54) LATCH SET CONDITION OF ELECTRIFIED VEHICLE POWER VIOLATION DIAGNOSTIC TROUBLE CODE TO PREVENT TOGGLING

(71) Applicant: FCA US LLC, Auburn Hills, MI (US)

(72) Inventors: Andrew Philip White, Auburn Hills, MI (US); Youchang Sun, Windsor (CA); Wenzhou Li, Windsor (CA)

(21) Appl. No.: 19/199,699

(22) Filed: May 6, 2025

(51) Int. Cl. B60W 50/029; B60L 58/12; B60W 50/02

(52) U.S. Cl. CPC B60W 50/029; B60L 58/12; B60W 50/0205; B60W 2050/021; B60W 2050/0292; B60W 2510/244

(57) ABSTRACT

Power monitoring and malfunction detection systems and methods for a high voltage battery system of an electrified vehicle a wireless battery pack control module (BPCM) and battery system sensors and calculating a state of power (SOP) of the battery system, selectively detecting a limp home malfunction and generating a request for a limp home mode in response thereto, detecting a power limit malfunction when the calculated SOP is greater than a power limit of the battery system, selectively set a diagnostic trouble code (DTC) based on (i) an enable signal corresponding to the limp home mode request and (ii) a duration of the power limit malfunction relative to a DTC maturation timer and, in reaction to detecting the power limit malfunction while setting the DTC, latch the enable signal to prevent an update of the request for the limp home mode that would cause a toggling of the DTC.

### FIELD

The present application generally relates to electrified vehicles and, more particularly, to a latch set condition of a power violation diagnostic trouble code (DTC) to prevent toggling.

### BACKGROUND

An electrified vehicle includes a high voltage battery pack or system that is configured to power one or more electric traction motors for vehicle propulsion. The battery system includes a plurality of battery modules, each of which includes a plurality of battery cells. A battery pack control module (BPCM) is a specific vehicle controller that receives measured parameters (voltage, current, temperature, etc.) from a plurality of sensors associated with the battery system and that calculates or estimates other parameters for the battery system (state of charge, or SOC, state of power, or SOP, etc.). SOP is a critical parameter for controlling the electrified powertrain (e.g., for charge/discharge limits of the battery system). During a “limp home” mode, power available for propulsion of the electrified vehicle is temporarily limited.

The limp home mode can be enabled, for example, during certain hardware malfunctions (e.g., battery cell over/under voltage limits). During the limp home mode, the power usage (SOP) of the battery system must be monitored to ensure that these reduced power limits are not violated. If these power limits are violated for longer than a threshold period of time, a diagnostic trouble code (DTC) for the electrified vehicle is set (e.g., a flag or signal). In some cases, the DTC can be inadvertently and temporarily healed and result in toggling of the DTC, which could be aggravating to consumers and could also result in wasted time/resources. Accordingly, while such conventional power monitoring and malfunction detection systems do work for their intended purpose, there exists an opportunity for improvement in the relevant art.

### SUMMARY

According to one example aspect of the invention, a power monitoring and malfunction detection system for a high voltage battery system of an electrified vehicle is presented. In one exemplary implementation, the power monitoring and malfunction detection system comprises sensors configured to measure parameters of the battery system and a wireless battery pack control module (BPCM) configured to establish a wireless communication link with the sensors and to receive, from the sensors via the wireless communication link, the measured parameters, calculate, based on at least some of the measured parameters, a state of power (SOP) of the battery system, selectively detect a limp home malfunction of the battery system and generate a request for a limp home mode in response thereto, detect a power limit malfunction when the calculated SOP is greater than a power limit of the battery system, selectively set a diagnostic trouble code (DTC) based on (i) an enable signal corresponding to the request for the limp home mode and (ii) a duration of the power limit malfunction relative to a DTC maturation timer, and in reaction to detecting the power limit malfunction while setting the DTC, latch the enable signal to prevent an update of the request for the limp home mode that would cause a toggling of the DTC.

In some implementations, the BPCM is configured to perform a DTC evaluation process while (i) the enable signal indicates the request for the limp home mode remains active and (ii) the power limit malfunction remains detected. In some implementations, the BPCM is configured to latch the enable signal when the power limit malfunction is detected after the DTC evaluation process and during the setting of the DTC to an active/inactive or ON/OFF state. In some implementations, without the latching of the enable signal, the request for the limp home mode temporarily deactivates and causes the DTC to temporarily and inadvertently toggle to the inactive or OFF state. In some implementations, the BPCM is configured to latch the enable signal by temporarily storing it in a memory or buffer.

In some implementations, the BPCM is configured to detect the limp home malfunction when a state of charge (SOC) of the battery system is outside of minimum and maximum SOC thresholds. In some implementations, the BPCM is configured to calculate the SOC of the battery system based on at least some of the measured parameters. In some implementations, the SOC of the battery system is outside of the minimum and maximum SOC thresholds due to invalid measured parameters from the sensors. In some implementations, the invalid measured parameters from the sensors are due to a temporarily break or interruption in the wireless communication link between the BPCM and the sensors.

According to another aspect of the invention, a power monitoring and malfunction detection method for a high voltage battery system of an electrified vehicle is presented. In one exemplary implementation, the power monitoring and malfunction detection method comprises establishing, by a wireless BPCM of the electrified vehicle, a wireless communication link with sensors of the electrified vehicle that are configured to measure parameters of the battery system, receiving, by the BPCM and from the sensors via the wireless communication link, the measured parameters, calculating, by the BPCM and based on at least some of the measured parameters, an SOP of the battery system, selectively detecting, by the BPCM, a limp home malfunction of the battery system and generate a request for a limp home mode in response thereto, detecting, by the BPCM, a power limit malfunction when the calculated SOP is greater than a power limit of the battery system, selectively setting, by the BPCM, a DTC based on (i) an enable signal corresponding to the request for the limp home mode and (ii) a duration of the power limit malfunction relative to a DTC maturation timer, and in reaction to detecting the power limit malfunction while setting the DTC, latching, by the BPCM, the enable signal to prevent an update of the request for the limp home mode that would cause a toggling of the DTC.

In some implementations, the power monitoring and malfunction detection method further comprises performing, by the BPCM, a DTC evaluation process while (i) the enable signal indicates the request for the limp home mode remains active and (ii) the power limit malfunction remains detected. In some implementations, the power monitoring and malfunction detection method further comprises latching, by the BPCM, the enable signal when the power limit malfunction is detected after the DTC evaluation process and during the setting of the DTC to an active/inactive or ON/OFF state. In some implementations, without the latching of the enable signal, the request for the limp home mode temporarily deactivates and causes the DTC to temporarily and inadvertently toggle to the inactive or OFF state. In some implementations, the power monitoring and malfunction detection method further comprises latching, by the BPCM, the enable signal by temporarily storing it in a memory or buffer.

In some implementations, the power monitoring and malfunction detection method further comprises detecting, by the BPCM, the limp home malfunction when an SOC of the battery system is outside of minimum and maximum SOC thresholds. In some implementations, the power monitoring and malfunction detection method further comprises calculating, by the BPCM, the SOC of the battery system based on at least some of the measured parameters. In some implementations, the SOC of the battery system is outside of the minimum and maximum SOC thresholds due to invalid measured parameters from the sensors. In some implementations, the invalid measured parameters from the sensors are due to a temporarily break or interruption in the wireless communication link between the BPCM and the sensors.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system and an example power monitoring and malfunction detection system according to the principles of the present application; and

FIG. 2 is a flow diagram of an example electrified vehicle power monitoring and malfunction detection method to mitigate or eliminate diagnostic trouble code (DTC) toggling according to the principles of the present application.

### DESCRIPTION

As previously discussed, a battery pack control module (BPCM) is a specific controller of an electrified vehicle that receives measured parameters (voltage, current, temperature, etc.) from a plurality of sensors associated with the battery system and that calculates or estimates various parameters for the battery system (state of charge, or SOC, state of power, or SOP, etc.). SOP is a critical parameter for controlling the electrified powertrain (e.g., for charge/discharge limits of the battery system). During a “limp home” mode, power available for propulsion of the electrified vehicle is temporarily limited. The limp home mode can be enabled, for example, during certain hardware malfunctions (e.g., battery cell over/under voltage limits). During the limp home mode, the power usage (SOP) of the battery system must be monitored to ensure that the reduced power limits are not violated. If these limits are violated for longer than a threshold period of time, a diagnostic trouble code (DTC) for the electrified vehicle is set (e.g., a flag or signal). In some cases, the DTC can be inadvertently and temporarily healed and result in toggling of the DTC, which could be aggravating to consumers and could result in wasted time/resources.

In one particular electrified vehicle embodiment, the BPCM is a wireless BPCM. More specifically, the BPCM is configured to communicate via one or more short-range wireless communication mediums (Bluetooth, WiFi Direct, Zigbee, etc.), such as with the sensors and/or a central controller or controller area network (CAN) of the electrified vehicle. Due to its wireless connectivity, the wireless BPCM could temporarily lose communication with the sensors, thereby causing the temporarily invalid sensor measurements. This establishment of wireless communication between the wireless BPCM and other electrified vehicle components (e.g., the sensors for the battery system) could also increase a length or duration of the key-on or wakeup period of the electrified vehicle (i.e., for purposes of waiting for valid measurements to for the SOP calculation and other calculations (e.g., SOC). In other words, the wireless BPCM could exacerbate the above-described DTC toggling problem, which would be even more noticeable and aggravating to consumers. Thus, while these conventional power monitoring and malfunction detection systems and methods do work for their intended purpose, an opportunity for improvement exists in the relevant art.

Accordingly, improved power monitoring and malfunction detection systems and methods for a high voltage battery system of an electrified vehicle are presented herein. The above-described DTC toggling problem can be a result of the request for the limp-home mode (a malfunction reaction to a power malfunction or fault) being an input enable condition for the DTC. However, the malfunction reaction for the DTC being set is a different, more severe malfunction reaction, which updates the signal communication the current (now previous) malfunction reaction. This change in the malfunction reaction signal (the request for the limp-home mode) to temporarily become false (e.g., zero), which leads to the DTC inadvertently and temporarily healing itself. These improved systems and methods implement a mechanism (i.e., a latch or memory/buffer) to preserve the enable condition for the DTC. This approach prevents toggling of the DTC where, after a maturation or dematuration timer expires, the original power limit malfunction would resurface leading to toggling of the DTC. Potential benefits of these techniques include an improved customer experience and/or reduced time/resources in addressing and remedying the underlying problem with the battery system of the electrified vehicle.

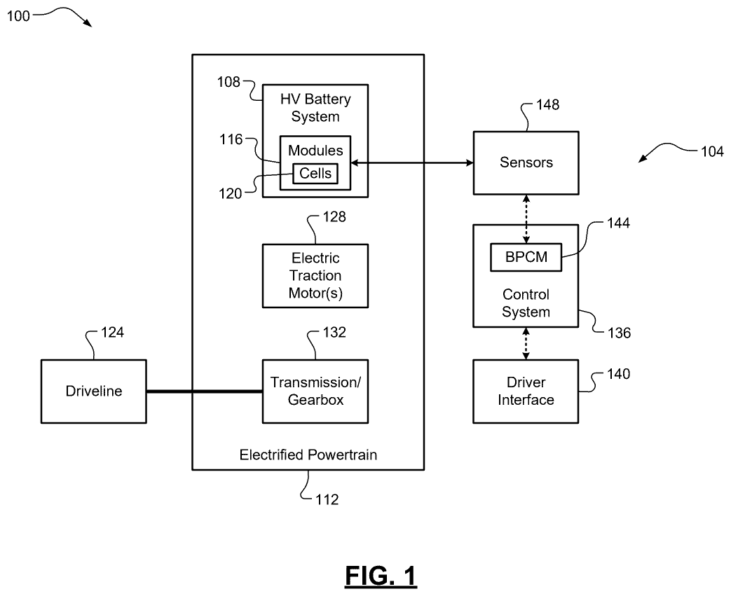

Referring now to FIG. 1, a functional block diagram of an electrified vehicle 100 having an example power monitoring and malfunction detection system 104 for a high voltage (HV) battery system 108 according to the principles of the present application is illustrated. The HV battery system 108 (also “battery system 108” herein) is part of an electrified powertrain 112 of the electrified vehicle 100 and the battery system 108 further comprises a plurality of battery modules 116 each comprising a plurality of battery cells 120. It will be appreciated that the battery system 108 could have any suitable configuration (e.g., a 400V or 800V DC battery system comprising, for example only, 13 battery modules each comprising 8 lithium-ion type battery cells). The electrified powertrain 112 is configured to generate and transfer drive torque to a driveline 124 for vehicle propulsion. More specifically, one or more electric traction motors 128 (e.g., one or more interior permanent magnet synchronous motors) are configured to be powered by the battery system 108 (e.g., via a three-phase inverter) and the electric traction motor(s) 128 is/are configured to generate drive torque that can be transferred to the driveline 124 via an optional transmission, gearbox, or gear reducer 132.

A control system 136, which can comprise a plurality of controllers or electronic control units (ECUs) connected or in communication with each other via a controller area network (CAN) or other suitable network, controls operation of the electrified vehicle 100, which primarily includes controlling the electrified powertrain 112 to generate and transfer to the driveline 124 a sufficient amount of drive torque to satisfy a driver torque request (e.g., received from a driver of the electrified vehicle 100 via a driver interface 140, such as an accelerator pedal device). For purposes of the present application, the control system 136 is shown to specifically include a BPCM 144, which controls/monitors the battery system 108, including receiving parameter measurements of the modules 116 or cells 120 via a plurality of sensors 148 (also “sensors 148” herein). It will be appreciated that the control system 136 could further include other modules/ECUs, such as a supervisory ECU (e.g., an electrified vehicle control unit, or EVCU), a motor control unit, a transmission control unit, and the like). The control system 136 (or, more specifically, the BPCM 144) is also further configured to execute at least a portion of the power monitoring and malfunction detection techniques of the present application. As mentioned above, the BPCM 144 receives measured parameters from the sensors 148.

Based on these measured parameters (current, voltage, temperature, etc.), the BPCM 144 can also estimate other parameters of the battery system 108, such as SOC (e.g., using a Kalman filter), OCV, and resistance. The measured parameters from the sensors 148 can at times be invalid (as opposed to valid). This could be the result of hardware malfunctions or due to a communication fault or malfunction (e.g., a break or interruption in a communication link between the BPCM 144 and the sensors 148). This can also occur at key-on or wakeup events of the BPCM 144. In one example embodiment, the BPCM 144 is a wireless BPCM that wirelessly communicates with the sensors 148 via a short-range wireless communication medium (Bluetooth, WiFi Direct, Zigbee, etc.) and this communication link could temporarily break or be interrupted and then subsequently reestablished. A wireless implementation for the BPCM 144 allows for more flexible vehicle packaging, but it also presents the challenges discussed in detail herein due to temporary communication losses. For example, the wireless BPCM 144 can suffer from temporarily invalid signals that require the more severe malfunction reaction than the limp home mode request as previously-described and that could cause toggling of the DTC.

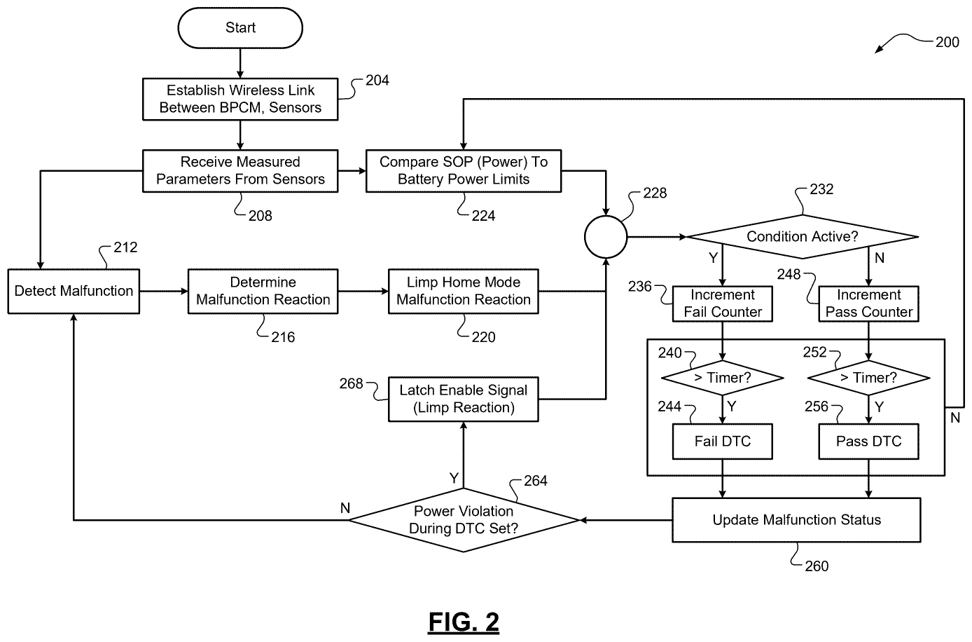

Referring now to FIG. 2 and with continued reference to the FIG. 1, a flow diagram of an example power monitoring and malfunction detection method 200 for a high voltage battery system of an electrified vehicle according to the principles of the present application is illustrated. While the method 200 specifically references the electrified vehicle 100 and its components (e.g., the battery system 108 and the BPCM 144), it will be appreciated that the method 200 could be applicable to any suitably configured electrified vehicle having a high voltage battery system with temperature sensor(s) and a wireless BPCM. The method 200 begins at 204 where the BPCM 144 receives measured parameters from the sensors 148. As previously discussed herein, non-limiting examples of these measured parameters include current, voltage, and temperature of either cells, groups of cells 120 (e.g., modules 116), or the battery system 108 as a whole. Provided there is an established, functional wireless communication link between the BPCM 144 and the sensors 148, the measured parameters should be valid (except for cases of sensor faults or other hardware malfunctions). At 208, the BPCM 144 calculates the SOP of the battery system 108 based on at least some of the measured parameters. This SOP estimation could be any suitable SOP calculation or estimation process, such as an SOP calculation based on OCV, resistance, and/or other parameters (SOC, current/voltage, etc.).

At parallel 212, the BPCM 144 determines whether any other (non-power limit) malfunctions are present. This could include, for example, a limp home malfunction where the limp home mode of the electrified vehicle 100 is requested. The limp home malfunction could be detected, for example, when the SOC of the battery system 108 exceeds or is outside of (i.e., not between) minimum and maximum SOC thresholds. In other words, the limp home malfunction can correspond to an overcharging or undercharging condition (or anticipation of a potential overcharging/undercharging condition) of the battery system 108, which could potentially damage the battery system 108 and could also result in the driver/passengers being stranded. The SOC is calculated or estimated by the BPCM 144 based on at least some of the measured parameters (current, voltage, temperature, etc.), which could involve the use of a trained model or filter (e.g., a Kalman filter). A temporary communication loss between the BPCM 144 and the sensors 148 could result in invalid measurements from the sensors 148 and, in turn, an invalid SOC and/or SOP.

As shown, from 212, the BPCM 144 can, in response to a detected malfunction (e.g., the limp home malfunction), determine a malfunction reaction at 216. For the limp home malfunction, this malfunction reaction is a request for the limp home mode (i.e., an active or ON request signal) as shown at 220. This limp home mode request is one of the enablers (i.e., an enable signal) for the DTC evaluation process that will now be described in greater detail. From 208 where the BPCM 144 calculates the SOP, the BPCM 144 then determines whether the SOP exceeds power limits of the battery system 108 (e.g., above a discharge power limit or below a charge power limit, which is negative) at 224. In the event that the limp home mode is active, the power limits of the battery system 108 could be reduced (i.e., less than normal minimum/maximum values). When the SOP exceeds the power limits at 224, the method 200 proceeds to 228. At 228, the BPCM 144 determines a condition (for the DTC evaluation process) when (i) the enable signal (the limp home mode request) is active/ON and (ii) the SOP exceeds the power limits. At 232, when both of these are satisfied, the condition is detected (active) and the method 200 proceeds to 236. Otherwise, from 232, the method 200 proceeds to 248. At 236, the BPCM 144 increments a fail counter. At parallel 248, the BPCM increments a pass counter.

At both 240 and 252, the BPCM 144 determines whether respective fail/pass maturation timers have been exceeded (i.e., the condition is detected/active for longer than one of these respective maturation timers). At 244, the BPCM 144 sets the DTC to a fail status. At parallel 256, the BPCM 144 sets the DTC to a pass status. From these parallel paths, the method 200 then proceeds either back to 224 (e.g., when neither maturation timer is satisfied to sufficiently determine a DTC status) or to 260, where the BPCM updates a malfunction status based on the DTC evaluation process (steps 236-256). At 264, the BPCM 144 determines whether the power violation (i.e., step 224) occurred during the setting of the DTC. When false, the method 200 returns to 212 where the malfunctions are determined and thereafter, at 216, the malfunction reaction is determines. When the DTC is set to fail, the malfunction reaction can be to request the limp home mode at 220. However, to prevent an update of the limp home mode request signal that could temporarily and inadvertently cause the limp home mode request to deactivate and thereafter cause the DTC to toggle, when the power violation (step 224) is detected during the setting of the DTC as determined at 264, the method 200 can proceed to 268 where the BPCM 144 can latch the enable signal (the limp home request) to active/ON to thereby mitigate or eliminate the toggling of the DTC that would otherwise occur without such latching.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A power monitoring and malfunction detection system for a high voltage battery system of an electrified vehicle, the power monitoring and malfunction detection system comprising:
sensors configured to measure parameters of the battery system; and
a wireless battery pack control module (BPCM) configured to establish a wireless communication link with the sensors and to:
receive, from the sensors via the wireless communication link, the measured parameters;
calculate, based on at least some of the measured parameters, a state of power (SOP) of the battery system;
selectively detect a limp home malfunction of the battery system and generate a request for a limp home mode in response thereto;
detect a power limit malfunction when the calculated SOP is greater than a power limit of the battery system;
selectively set a diagnostic trouble code (DTC) based on (i) an enable signal corresponding to the request for the limp home mode and (ii) a duration of the power limit malfunction relative to a DTC maturation timer; and
in reaction to detecting the power limit malfunction while setting the DTC, latch the enable signal to prevent an update of the request for the limp home mode that would cause a toggling of the DTC.

2. The power monitoring and malfunction detection system of claim 1, wherein the BPCM is configured to perform a DTC evaluation process while (i) the enable signal indicates the request for the limp home mode remains active and (ii) the power limit malfunction remains detected.

3. The power monitoring and malfunction detection system of claim 2, wherein the BPCM is configured to latch the enable signal when the power limit malfunction is detected after the DTC evaluation process and during the setting of the DTC to an active/inactive or ON/OFF state.

4. The power monitoring and malfunction detection system of claim 3, wherein without the latching of the enable signal, the request for the limp home mode temporarily deactivates and causes the DTC to temporarily and inadvertently toggle to the inactive or OFF state.

5. The power monitoring and malfunction detection system of claim 1, wherein the BPCM is configured to latch the enable signal by temporarily storing it in a memory or buffer.

6. The power monitoring and malfunction detection system of claim 1, wherein the BPCM is configured to detect the limp home malfunction when a state of charge (SOC) of the battery system is outside of minimum and maximum SOC thresholds.

7. The power monitoring and malfunction detection system of claim 6, wherein the BPCM is configured to calculate the SOC of the battery system based on at least some of the measured parameters.

8. The power monitoring and malfunction detection system of claim 7, wherein the SOC of the battery system is outside of the minimum and maximum SOC thresholds due to invalid measured parameters from the sensors.

9. The power monitoring and malfunction detection system of claim 8, wherein the invalid measured parameters from the sensors are due to a temporarily break or interruption in the wireless communication link between the BPCM and the sensors.

10. A power monitoring and malfunction detection method for a high voltage battery system of an electrified vehicle, the power monitoring and malfunction detection method comprising:
establishing, by a wireless battery pack control module (BPCM) of the electrified vehicle, a wireless communication link with sensors of the electrified vehicle that are configured to measure parameters of the battery system;
receiving, by the BPCM and from the sensors via the wireless communication link, the measured parameters;
calculating, by the BPCM and based on at least some of the measured parameters, a state of power (SOP) of the battery system;
selectively detecting, by the BPCM, a limp home malfunction of the battery system and generate a request for a limp home mode in response thereto;
detecting, by the BPCM, a power limit malfunction when the calculated SOP is greater than a power limit of the battery system;
selectively setting, by the BPCM, a diagnostic trouble code (DTC) based on (i) an enable signal corresponding to the request for the limp home mode and (ii) a duration of the power limit malfunction relative to a DTC maturation timer; and
in reaction to detecting the power limit malfunction while setting the DTC, latching, by the BPCM, the enable signal to prevent an update of the request for the limp home mode that would cause a toggling of the DTC.

11. The power monitoring and malfunction detection method of claim 10, further comprising performing, by the BPCM, a DTC evaluation process while (i) the enable signal indicates the request for the limp home mode remains active and (ii) the power limit malfunction remains detected.

12. The power monitoring and malfunction detection method of claim 11, further comprising latching, by the BPCM, the enable signal when the power limit malfunction is detected after the DTC evaluation process and during the setting of the DTC to an active/inactive or ON/OFF state.

13. The power monitoring and malfunction detection method of claim 12, wherein without the latching of the enable signal, the request for the limp home mode temporarily deactivates and causes the DTC to temporarily and inadvertently toggle to the inactive or OFF state.

14. The power monitoring and malfunction detection method of claim 10, further comprising latching, by the BPCM, the enable signal by temporarily storing it in a memory or buffer.

15. The power monitoring and malfunction detection method of claim 10, further comprising detecting, by the BPCM, the limp home malfunction when a state of charge (SOC) of the battery system is outside of minimum and maximum SOC thresholds.

16. The power monitoring and malfunction detection method of claim 15, further comprising calculating, by the BPCM, the SOC of the battery system based on at least some of the measured parameters.

17. The power monitoring and malfunction detection method of claim 16, wherein the SOC of the battery system is outside of the minimum and maximum SOC thresholds due to invalid measured parameters from the sensors.

18. The power monitoring and malfunction detection method of claim 17, wherein the invalid measured parameters from the sensors are due to a temporarily break or interruption in the wireless communication link between the BPCM and the sensors.
